(19) United States
(12) Patent Application Publication
(10) Pub. No.: US 2007/0130929 A1
(43) Pub. Date: Jun. 14, 2007

(54) Wave power generator

(76) Inventors: Ghazi Khan, Lincoln, CA (US); Shahnaz Khan, Lincoln, CA (US)

Correspondence Address: Ghazi Khan, 2563 Granite Park Dr., Lincoln, CA, 95648, US

(21) Appl. No.: 11/327,003

(22) Filed: Jan. 6, 2006

Related U.S. Application Data
(60) Provisional application No. 60/749,571, filed on Dec. 13, 2005.

(51) Int. Cl. F16D 31/02

(52) U.S. Cl. 60/398

(57) ABSTRACT

A machine and a process to produce compressed air by sea waves, using the weight of the floating platform with its fixture using its up and down movement to compress air in both directions to absorb the maximum energy of that wave in a direct drive bidirectional pump with a single piston wherein the kinetic energy and wave bouncy force is used to compress ambient air as stored energy. This unique arrangement doubles air volume for compression in both directions in any single wave curve, doubles the energy production in both upper and lower chambers of the pump and multiplies the “psi” based on the float thrust area against the size of the piston in the pump. The preferred embodiment can be used as a stand alone unit as well as in array formation for the desired output 24/7.

### BACKGROUND OF THE INVENTION

This invention relates generally to the field of energy extraction from sea waves and more specifically to a machine and a process to produce compressed air energy by sea waves using water bounacy and kinetic energy using both sides of the wave curve in a single cylinder in a most simple reliable yet economical way. The process of utilizing full wave curve increases the efficiency and doubles the production.

There have been many attempts to find a viable option to harness sea wave energy. Mostly the attempts were made at a governmental level or international scale. Few non profit organizations and some private companies tried some ventures with the help of their respective governments and universities using public fundings, however no one has come up with a very low budget but efficient solution to bring this venture within the reach of average entrepreneur. Many universities have tried to box the wave energy with different ways. Few companies has tried to use different variations of different closed loop systems, but a viable efficiency could not be achieved because the required pressure could not be achieved by simply covering the wave raised area to gain air pressure, as the pressure distributes evenly in all directions therefore the pressure at the exit side diminishes significantly therefore air velocity is used as a last resort. Secondly during inflation and deflation cycles, a major portion of incoming energy is cancelled out by the outgoing deflating energy. Therefore the pioneers have been using a small portion of a half curve of the sea wave resulting in little success.

All conventional and unconventional wave energy devices have been classified into two basic families. One is wave power systems and the second is oscillating water columns. There are four more families for extracting sea wave energy namely, Axial-flow turbines, cross-axis turbines, lift or flutter vanes and hydraulic tapped ducted systems. The following wave energy conversion devices has been used in the past,

1. Pelamis by Ocean Power Delivery LTD of Edinburgh, Scotland

2. OWC by Energetech of Australia, Connecticut

3. Wave Dragon of Denmark

4. Wave Swing by TeamWorks of Netherlands

5. AquaBuoy by AquaEnergy of Washington, USA

6. Sea Dog by Indep. Natural Res. Inc of Minnesota, USA

7. MRC1000 by Orecon of UK

8. Wave Bob of UK

9. Floating Buoy by Ocean Power Technologies of New Jersey, USA

Whist significant technological advances have been made in the conversion of energy from some of these alternative areas such as wind and solar, the majority of wave powered generation systems proposed to date has not been physically practical and/or economically viable.

In this regard, numerous different types of wave powered generation systems have been proposed, most of which are founded on the basic principle of using the vertical motion inherent in the movement of waves to effect a corresponding displacement of a component of the generating system. However, all of the systems proposed so far have had their limitations.

For example, one such system utilizes oscillating floating paddles, the motion of which is converted directly or indirectly to electrical power. However, these floating paddle systems generally have low energy conversion efficiency and are unable to withstand adverse weather conditions.

Other systems include those based on the concept of channeling the waves through water displacement pumps, or alternatively into large accumulators or reservoirs, the hydrostatic pressure of the stored water subsequently being used to drive a turbine generator or the like. Again, the overall energy conversion efficiency is relatively low given the associated capital costs.

One of the alternative types of systems proposed so far, is that in which the vertical movement of the waves is translated to rotary movement to directly or indirectly drive a generator. In these systems the rising and falling sea water is channeled toward and harnessed within an air compression chamber. The chamber has at its exit an outlet duct or venturi, in which is located a wind turbine of a kind operable to rotate unidirectional under the periodically oscillating air flows induced by the wave motion.

Again, the main deficiencies with these latter wave driven air turbine systems, is the restricted overall achievable energy efficiencies. This is due primarily to the limitations firstly in the means of focusing the wave energy to maximize the wave displacement amplitude, and secondly in the operating efficiencies inherent in the turbine design.

In the first case, most of the prior art wave focusing devices have relied on planar reflection of the wave front and/or channeling of the wave front through a narrowed opening such that the vertical displacement or amplitude of the wave is magnified. Others include various means to alter the formation of the sea bed to controllably disrupt the wave propagation, so as to thereby maximize the wave amplitude at a predetermined location. Once again these types of systems have been limited so far in respect of the maximum achievable wave amplification for a given level of capital expenditure.

In the second case most prior art turbines are designed for constant velocity rotation in response to fluid flow in one direction only, and as such are unable to operate continuously in response to the reversing fluid flow conditions present in wave powered applications of the kind discussed above. However, a number of specially configured unidirectional turbines have been designed for these reversing flow conditions, the most commonly used devices being based on what is known as the “Wells” turbine.

The original Wells turbine was of a monoplane axial fan type structure having radially extending blades of an aerofoil section that are generally symmetrical about the chord line, where the blades are fixed with their planes of zero lift normal to the axis of the rotor.

However, these early turbines were known to suffer from stalling, often resulting in the shut down of the wave energy harnessing plant. This stalling occurs due to the fact that such a turbine needs to be designed around anticipated levels of air flow, whereas the size of the waves entering the turbine chamber cannot be controlled for all occasions. Therefore, when a larger sized wave enters the chamber, its momentum causes a correspondingly greater air flow rate through the turbine blades. As the rate of rotation of the blades is usable, with its blade configuration, to increase correspondingly to counter this increased airflow, the angle of attack of the airflow to the blades increases beyond the stalling angle and the turbine shuts down.

Some later prior art devices have attempted to overcome this problem by effectively installing two monoplane Wells turbines in series resulting in a bi-plane turbine. While this modified system solves the stalling problem, it does so at a penalty to the overall efficiency. This is because it sacrifices the first set of blades by allowing them to correspondingly stall and shut down, the second set of blades then continuing operation at a reduced pace and efficiency. This is due to the total air flow rate having now been decreased and smoothed out by the stalling and interruption of the air flow by the first turbine.

These prior art turbines also usually rely on a low revving high mass construction in order to ensure smooth continuous rotation under periodically reversing driving air flows of the kind contemplated.

It will therefore be-appreciated that most prior art turbines suited to this type of application are often quite complex in design and usually have severe limitations in relation to operating conditions and/or efficiencies.

In the prior art the issue of air pressure caused by the wave must be substantial enough to open the exit valves in a pump. In the present device this issue has been solved by designing to extract low pressure air like 50 psi and stored in air holding tanks and then boosted by air powered boosters to compress its own air volume up to the required psi. Secondly the air volume “CSFM” is increased by using larger pumps for greater production of compressed air which is again doubled by using bidirectional pump wherein both sides of the energy of the full wave curve is extracted by the water bouncy as well as the weight of the floating structure to exert its own weight to push the piston down by using kinetic energy caused by the wave to complete its cycle.

In the prior art most wave energy extraction devices were based on spinning motion but they were not effective enough because the frequency of waves and its force is always unpredictable therefore the momentum of spinning “RPM” cannot be maintained without compromising with its efficiency. In the present device, piston is directly driven by the float movement to gain full bouncy force based on the size of the float acting as larger open piston and the other end of the piston inside the stationary pump cylinder to compress the air in both up and down directions.

In the prior art pumps have been used to compress air but they were designed to take advantage of the half cycle of the wave curve only whereas in the present device both sides of the wave curve is used, half by the bouncy of the wave and the other half with the kinetic energy as dropping weight of the float to run the rest of the half curve of the wave with twice the outcome of compressed air production.

It is an object of the present invention to provide a wave energy extracting system and/or one or more of the components thereof, which overcomes or at least ameliorates one or more of the above discussed disadvantages of the prior art, or at least offers a useful alternative thereto.

This is the simplest, reliable, predictable and low cost direct driven system for commercial air compression station for sustainable use without interruptions. Other embodiments are either indirect or much complicated to be economically viable.

These stations will be built on the coast line exclusively and will be partially based on land and the rest part will be over the belt that separates the sea and the ocean. There units are not basically designed for deep sea operation however they can be designed by using the technology of making either piston or the cylinder stationary by means of cables or anchors to make them stationary as compared with the freely moving part. This is the only invention that is land based as well as in part sea shore based in a most simple way.

Another aspect of this uniqueness is the depth of location that makes a big difference as compared to deep sea devices. This machine and process will work best near the shoreline where the appearance of waves is more visible as they approach the shoreline. The machine and the process uses the “up and down” movement of waves to directly drive a simple bi directional pump to create compressed air as an energy storage medium.

Some old embodiments use water as a working medium and then convert that energy into to run water powered turbines; In this preferred embodiment a duel working medium is used, water and air independently in total sync to extract double energy. The difference is critical because water cannot be compressed and also known as liquid iron in hydraulics. On the contrary air is compressible and the technique to benefit from both mediums by using the up and down motion of waves to transfer that energy into the air medium to use the wave force for air compression and then use kinetic energy to multiply the gain by a factor of two in the simplest possible way.

Some older embodiments use compressed air by applying indirect method of using the bouncing movement of water wave. Their captured energy is not even half the capacity that could be captured by using full potential of the wave energy by the falling weight of the wave.

Some prior art have tried to keep their air pumps under the sea where the supply of ambient air is not possible and air has to be driven by some mechanical method. The current embodiment takes atmospheric ambient air directly from its surroundings without the need for any device at all.

Some prior art use a single cycle stroke or reciprocal stroke using the bouncing force of the wave but prior art has failed to extract direct energy of the weight of the sinking wave in any prior art.

Some prior art has tried to use both wave cycle energy by compressing the air in a tight vessel and decompression created by the sinking wave to run turbine but their process has a major defect of self cancellation of two air columns in opposite direction wherein its efficiency is seriously compromised.

In the current embodiment, the air pump is set above the sea level and that makes a big difference because not only it is easy to monitor and repair if needed but also perfectly safe for marine life and environment.

In the current embodiment the energy of the wave is mostly absorbed by adding up arrays in columns that are safe barriers against high impact waves to neutralize their destructive power to a certain degree.

### BRIEF SUMMARY OF THE INVENTION

The primary advantage of the invention is to provide very low cost sustainable energy to the consumers.
Another object of the invention is to provide a low budget stand alone units as a source of surplus income for coastal residents to produce their own power for their homes, workshops or sell it to anyone else for profit.
Another advantage of the invention is to the fishermen as they can produce power with their boat while in anchored position.
A further advantage of the invention is device that is most simple, cheaper to manufacture, yet more reliable to establish compressed air stations by sea waves, the only costs involved are local construction & Maintenance only.
Yet another object of the invention is that the energy so produced can be applied to run automobile industry without causing any kind of pollution saving billions on health care.
Still yet another object of the invention is to produce double energy using new technology as compared with the prior art in its size.
Other objects and advantages of the present invention will become apparent from the following descriptions, taken in connection with the accompanying drawings, wherein, by way of illustration and example, an embodiment of the present invention is disclosed.

In accordance with a preferred embodiment of the invention, this is a simple device that uses, not be limited to, wave energy to compress air in a bi-directional method which greatly reduces any wasted motion in this process.

In accordance with a preferred embodiment of the invention, this low-cost compressed air station is designed but not limited to commercial use and due to the overall simplicity of the design can sustain function ability without interruptions. This compressed air station is comprised of a number of parts, each simple but necessary.

In accordance with a preferred embodiment of the invention, it is disclosed that this low-cost compressed air station's housing is attached to the body of water's floor by anchors or bolts; this keeps the unit itself from moving. Inside this housing is a floating platform which can be comprised any type of floating material, i.e., wood, cork, plastic, fiber, metal, composite or synthetic material, but not limited to the previously mentioned material. The float runs off of guide wheels which are free moving with the motion of the waves either directly or indirectly, upon movement of the float the attached piston rod moves the piston up and down.

In accordance with a preferred embodiment of the invention, it is disclosed that the float guide wheels can be substituted with holes in the float, if so desired to cut the costs by passing guide rods through it giving the float a free gliding motion with the waves.

In accordance with a preferred embodiment of the invention, it is disclosed that the piston is housed in an upper cylinder or the lower chamber which has incorporated two compressed outlets with one way valves, one is at the upper edge of this chamber and the second is located at the lower edge or can be located anywhere to the pump to collect compressed air from upper and lower chambers and may be having multiple valves for any single chamber of the pump.

In accordance with a preferred embodiment of the invention, it is disclosed that this simple device works as follows; as the current or wave rises and/or falls, the float moves, this movement causes the piston to move in an up and down motion, and because there is constant pressure in the reciprocating chamber air is continuously compressed through either the upper or lower one way valve or group of one way valves.

In accordance with a preferred embodiment of the invention, it is disclosed that unlike other prior art, this low-cost compressed air station does not use water as the only working medium, this product uses air and water both as a working medium independently for air pumping which is compressible by using the up and down as well as unidirectional column pressure to extract the maximum wave energy force in the simplest way possible.

In accordance with a preferred embodiment of the invention, it is disclosed that in this unique process of extracting sea wave energy, full wave curve is used, the water bouncy thrust towards the upper curve as well as kinetic energy gain is used by the gravity to compress air in the lower chamber of the pump in lower curve of the wave resulting in a double gain of energy from sea waves is made possible.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1:

The vertically mounted wave air compressing station #100, pumps air through a pipe #101 to a compressed air storage tank #102. The station is supported by posts #104, which are anchored at their feet #105 in the sea floor. A float #103 is forced up and down by the vertical movement of the water by wave action. The movement of the float #103 is guided by wheels which ride in tracks #107 in the support posts #104. A platform #109 supports an air compression cylinder #108 above the float #103. A piston #110 mounted on the float #103 is forced up and down inside the air compression cylinder #108 such that compressed air is forced out of the cylinder through a valve #112A on the upward stroke of the piston and through a valve #112B on the downward stroke. Uncompressed air is sucked in from the outside through valve #111A on the downward stroke and through valve #111B on the upward stroke.

FIG. 2:

The angle-mounted wave air compressing station #200, pumps air through a pipe #101 to a compressed air storage tank (not shown). This station is designed to be installed in shallow water near a beach in order to harness the energy from the movement of water up and down the beach by wave action. A Wave catching unit (forward momentum of wave energy extractor) #201 is mounted on a support platform #202 which slides on tracks #203 that are mounted on the sea floor up to the coast line, employs a concave cup #204A to catch onshore waves and force the wave catching unit #201 uphill on the tracks #203. Receding water is caught by concave cup #204B, forcing the wave catching unit to move back down the tracks #203, in preparation for catching the next onshore wave. A piston #110 is attached to the wave catching unit #201 and travels inside an air compression cylinder #108. The air compression cylinder #108 is mounted on supporting posts #105 to the sea floor such that it is at the approximate angle of the gradient of the beach.

FIG. 3:

FIG. 300 represents an array or battery of air compression stations #100, which are represented in the figure by simple pistons. A detailed drawing of one of these air compression stations can be found on sheet 1. The line #301 represents the curvature of a wave as it moves through the array of air compression stations #100 toward the shoreline #302. The piston in each air compression station #100 moves vertically in accordance with the height of the wave at its location.

FIG. 4:

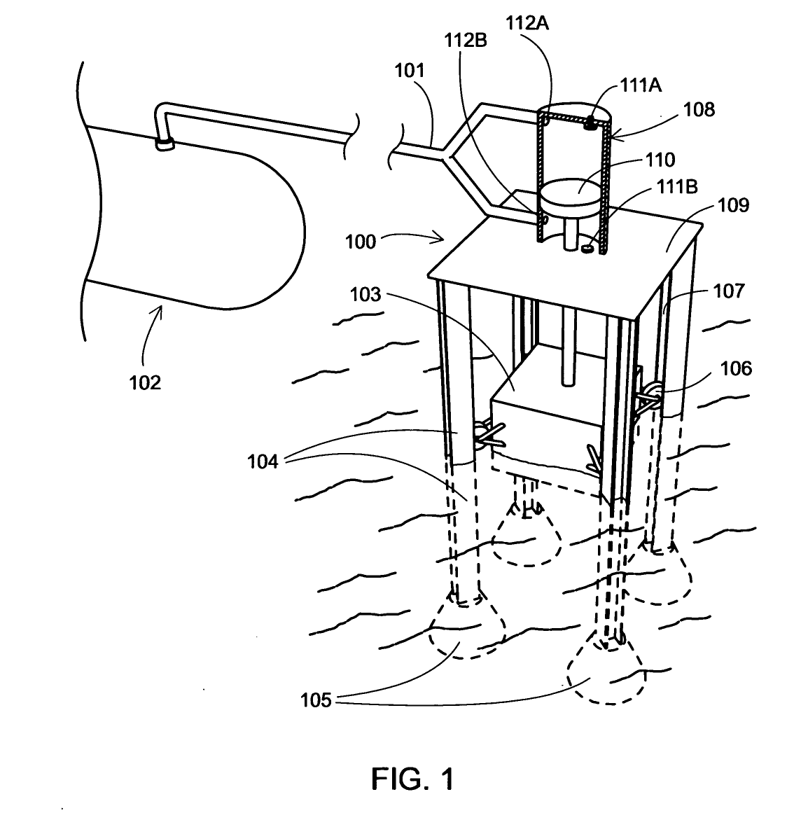

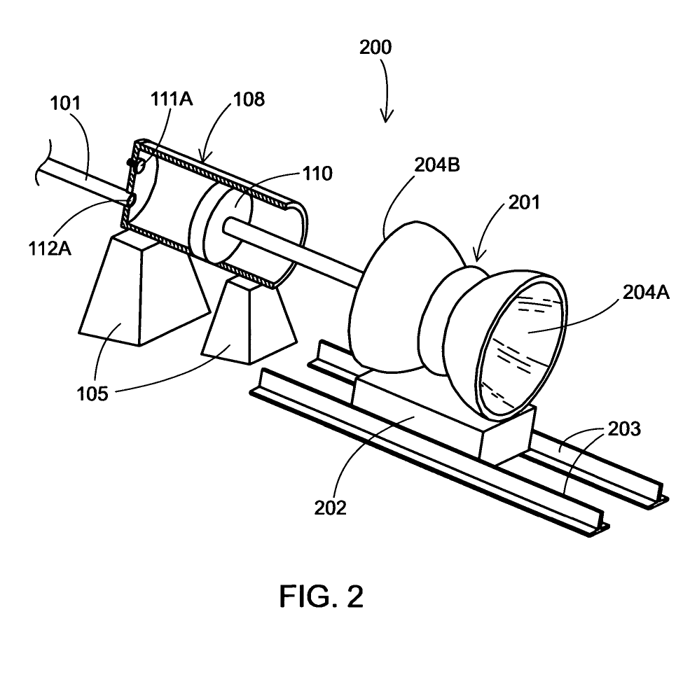

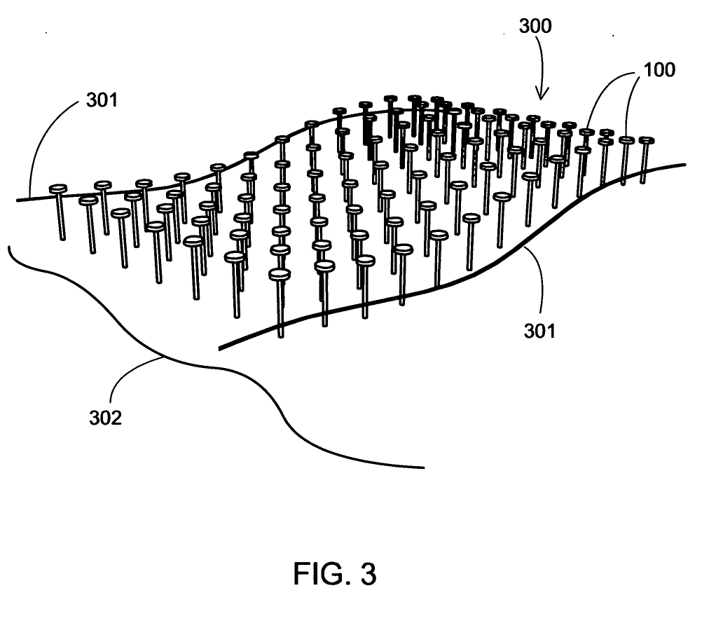

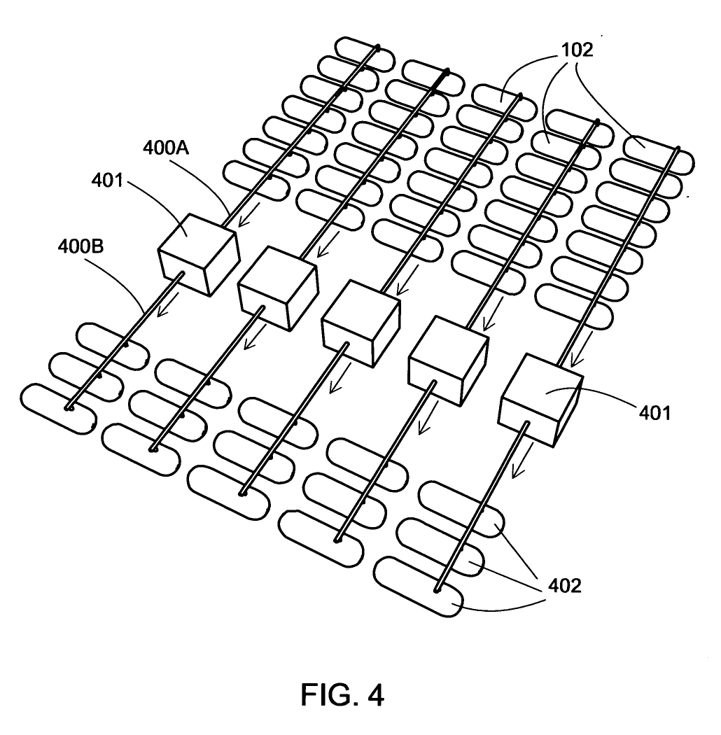

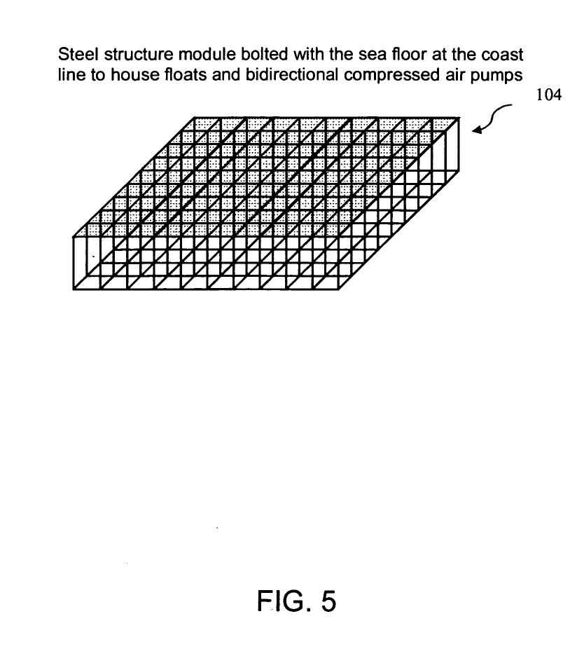

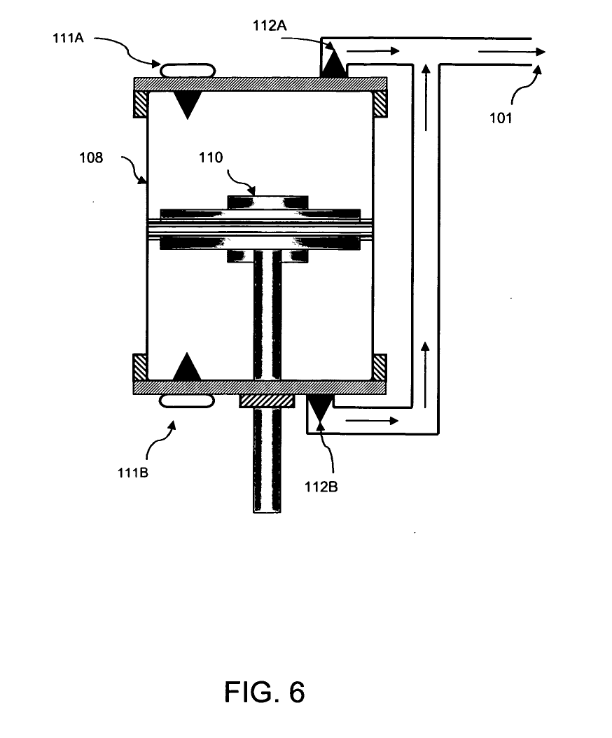

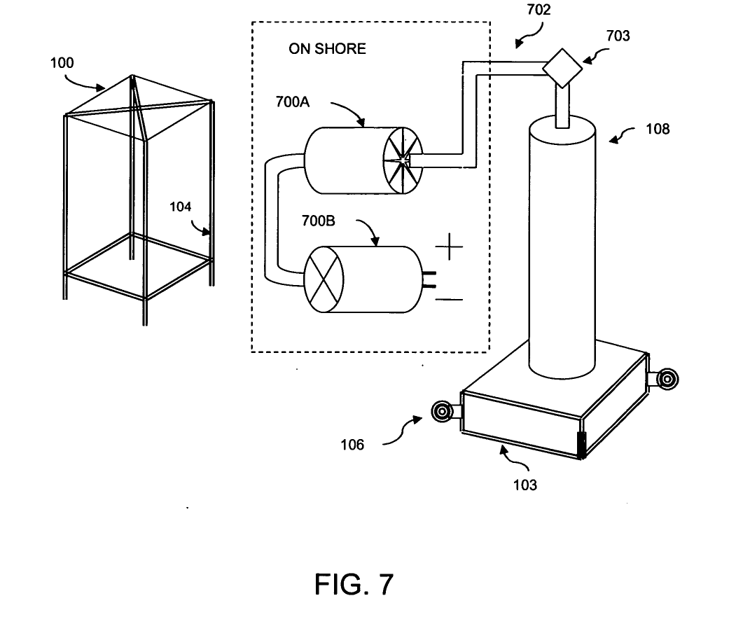

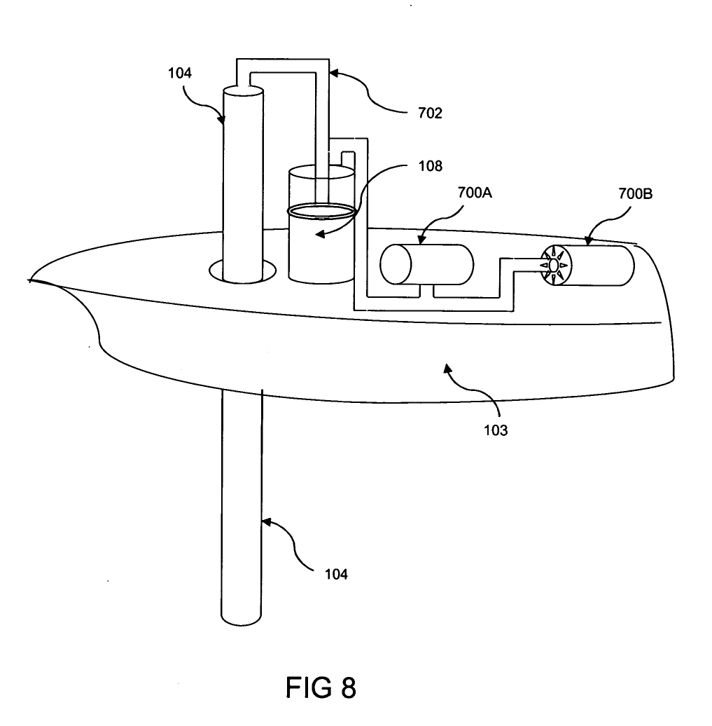

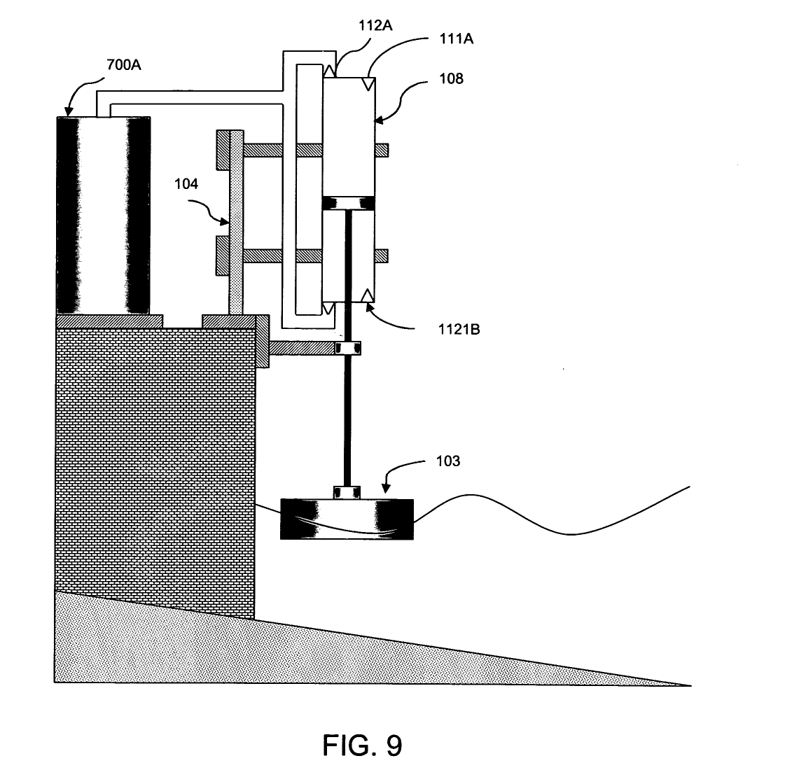

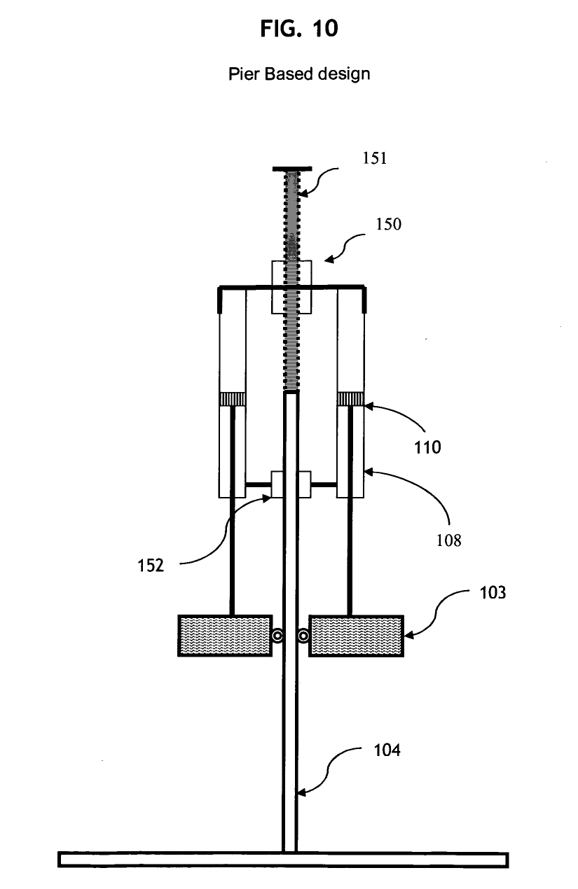

An array of compressed air storage holding tanks #102, are supplied with compressed air by air compression stations #s (100 or 200) not shown—see FIGS. 1-3) These compressed air storage tanks #102 in turn supply excess compressed air via pipes #404A to air compressors #401. The air compressors #401 compress the air further and supply it via pipes #400B to high compression boosted compressed air tanks #402, which may be stored underground.

FIG. 5:

An array formation as module comprised of multiple basic unit structure #104 is shown to house the float and pump assembly.

FIG. 6:

Bidirectional pump detail with its piston #110, two air intake one way valves #11A & #11B on each side of the pump cylinder. Compressed air outlet one way valves #112A & #112B and connecting tube for outgoing compressed air #101 for storage are shown.

FIG. 7:

FIG. 7 represents frame 104 with a top 100, an off shore air turbine #700A connected with a generator #700B connected by a pressure pipe #702 from a air moisture remover unit #703 and connected with the bidirectional pump #108 mounted over the float #103 and gliding along with its frame structure #104 with the sea waves in up and down motion with wheels #106.

FIG. 8:

FIG. 8 represents a float #103 anchored with a pier or pole #104 as stationary structure against the body of the float. A piston rod #702 stationary with structure #104 whereas the float #103 has a fixed pump cylinder #108. As the float #103 moves with the wave motion the attached pump cylinder also moves but not the piston and its attached rod. The movement of the float creates pumping action in the cylinder with stationary piston. The compressed air is fed in the air turbine #700 A that is connected with a generator 700B to produce power.

FIG. 9:

FIG. 9 represents a wall mounted compressed air unit where the float #103 is connected to the piston by a rod through a guide wherein the structure #104 holds the bidirectional pump. Air inlet valves #111A & 111B let the ambient air in the expansion cycle in each chamber and one way valve #112A shown and 112B not numbered takes the compressed air into the air storage cylinder #700A wherein the cylinder and structure is bolted in the retaining wall structure.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In accordance with a preferred embodiment of the invention, this is a simple device that uses, not be limited to, wave energy to compress air in a bi-directional method which greatly reduces any wasted motion in this process.

In accordance with a preferred embodiment of the invention, this low-cost compressed air station is designed but not limited to commercial use and due to the overall simplicity of the design can sustain function ability without interruptions. This compressed air station is comprised of a number of parts, each simple but necessary.

In accordance with a preferred embodiment of the invention, it is disclosed that this low-cost compressed air station's housing is attached to the body of water's floor by anchors or bolts; this keeps the unit itself from moving. Inside this housing is a floating platform which can be comprised any type of floating material, i.e., wood, cork, plastic, fiber, metal, composite or synthetic material, but not limited to the previously mentioned material. The float runs off of guide wheels which are free moving with the motion of the waves either directly or indirectly, upon movement of the float the attached piston rod moves the piston up and down.

In accordance with a preferred embodiment of the invention, it is disclosed that the float guide wheels can be substituted with holes in the float, if so desired to cut the costs by passing guide rods through it giving the float a free gliding motion with the waves.

In accordance with a preferred embodiment of the invention, it is disclosed that the piston is housed in an upper cylinder or the lower chamber which has incorporated two compressed outlets with one way valves, one is at the upper edge of this chamber and the second is located at the lower edge or can be located anywhere to the pump to collect compressed air from upper and lower chambers and may be having multiple valves for any single chamber of the pump.

In accordance with a preferred embodiment of the invention, it is disclosed that this simple device works as follows; as the current or wave rises and/or falls, the float moves, this movement causes the piston to move in an up and down motion, and because there is constant pressure in the reciprocating chamber air is continuously compressed through either the upper or lower one way valve or group of one way valves.

In accordance with a preferred embodiment of the invention, it is disclosed that unlike other prior art, this low-cost compressed air station does not use water as a working medium, this product uses air as a working medium for air pumping which is compressible by using the up and down as well as unidirectional column pressure to extract the maximum wave energy force in the simplest way possible.

In accordance with a preferred embodiment of the invention, it is disclosed that in this unique process of extracting sea wave energy, full wave curve is used, the water bouncy thrust towards the upper curve as well as kinetic energy gain is used by the gravity to compress air in the lower chamber of the pump in lower curve of the wave and as a result a double gain of energy is extracted.

Objects:

The primary advantage of the invention is to provide very low cost sustainable energy to the consumers.
Another object of the invention is to provide a low budget stand alone units as a source of surplus income for coastal residents to produce their own power for their homes, workshops or sell it to anyone else for profit.
Another advantage of the invention is to the fishermen as they can produce power with their boat while in anchored position.
A further advantage of the invention is device that is most simple, cheaper to manufacture, yet more reliable to establish compressed air stations by sea waves, the only costs involved are local construction & Maintenance only.
Yet another object of the invention is that the energy so produced can be applied to run automobile industry without causing any kind of pollution saving billions on health care.
Still yet another object of the invention is to produce double energy as compared with the prior art.

Qualities and Benefits:

This device is most simple, cheaper to manufacture, yet more reliable to establish compressed air stations by sea waves.

Air is compressed by using the most simple bidirectional pump powered by sea waves & Kinetic energy so caused by the gravity as its sole driver.

The only costs involved are construction & Maintenance. The energy is free 24/7.

The energy production doubles by using the weight of the float, its connecting rod and piston combined to drop freely by gravity down through its guide rails, compressing the air beneath the piston in reverse motion and converting the sinking wave cycle into useful energy.

In the raising cycle of the wave the float and piston connected with a rod also raises and the wave bouncy force of the float is used to compress the air in the pumping cylinder to produce useful energy that channeled through pipes into the holding cylinders.

The air is collected in the holding cylinders and compressed further by its own force by compressed air boosters, and is held in transportable units for various applications or may be used to generate very low cost electricity.

Prior art of harnessing sea wave energy had been focused in the raising cycle only using the same volume of air that originally was trapped in their respective devices, resulting in major reduction of pressure due to the same volume distributing the Psi evenly in all directions diminishing the pressure based on the size of the exit hole

For example a 5 Ton thrust force by sea wave may generate less than 25 psi based at the exit point where the turbine is set to work.

In this current embodiment the same 5 tone force is transferred through a shaft to the piston with a smaller diameter to compress air resulting in tremendous buildup pressure inside the pump which is useful energy when accumulated with multiple bi-directional pumps using both wave energy as well as kinetic energy using the second half of the wave curve produced by gravity.

Primary Elements:

The Float:

The float weight is set to a variable range preferable with available water, as compared to other floats where its sole purpose is to be all out over the surface to remain afloat for the following reasons:

When the float raises up by wave action and its attached piston compress the air in the preferred embodiment device, the air is drawn in the lower chamber of the cylinder by its open valve and when the wave passes, the combined weight of the float its connecting rod and piston compresses the air down that is trapped inside the lower chamber to keep on the compression in the next half cycle in the lower chamber. In other words the kinetic energy that is built during the raising cycle of the float is used to compress the air again in its free fall position resulting in a net gain of double energy extraction by this preferred embodiment.

In the current embodiment the float weight is a balancing tool to match the bouncing strike with the free fall weight stroke to efficiently use the compression of the opposing chamber to capture the other half energy of the wave.

The float is not designed for stabilization by any positive displacement of air or by any other device as it is heavily emphasized by the current technology. In this preferred embodiment, the principle is reverse and a maximum destabilization of the float is a requirement however a path is provided for movement to run a pumping action on both ends of the cylinder with a single piston.

This unique process makes the float a larger piston working with water as medium, whereas the smaller piston connected with a shaft works with the air medium inside the pump to amplify the pressure psi directly proportional to the ratio between the smaller piston and the larger piston “(The Float)”

Some prior art has tried to use tension wires, springs or other mechanical methods to pull the float back but it inversely affects the performance of the compression in the first cycle and because of the resistance it deceases its compression by wasting this energy.

The float design may be round, oval, triangle, square, rectangle, parallelogram, trapezoid, diamond shape, octagon, pentagon, hexagon, can, cube, cross, bevel, donut, chevron or any of these or a combination of these shapes, either hollow or solid or both can be made so long as they follow the basic principle of floatation and transmitting the motion of the waves to the piston.

Bi-Directional Pump:

In some prior art bidirectional pumps have been made with complex mechanism and especially their complexity is housed inside the pump body which seriously compromises its air volume in its size by taking space due to their design to let the air a passage by internal tubing and that drops its efficiency. In the current embodiment there is no junk inside the pump housing except its simple piston connected with a rod for its movement to produce useful energy. All necessary tubing is designed outside the pump housing giving the pump not only simplicity but also great efficiency by its enhanced air volume. No other kind of pump provides that simplicity and efficiency by comparison.

Energy Extraction in Shallow Water

Many inventors have tried to put all the mechanical jargon like a complete electrical system with electrical generators at the site and since they are designed for deep sea sites therefore they cannot perform with efficiency at shallow water sites. This preferred embodiment is designed for shallow water coast line wave energy extraction and collection or processing is land based. Low compressed air is produced by using both sides of the wave curve by direct bi-directional pumping. Land based compressed air tanks store that compressed air in the holding tanks and in the second phase the holding tanks energy is boosted by air powered boosters for high compression and transferred into high pressure tanks for either transportation like other fuel, electricity generation or used as a compressed air station.

Direct Driven System:

This is the simple most direct pumping system to get compressed air. The prior art was designed to use the compressed air to drive electric turbines directly, that are dependent upon the availability of waves, their strength and a waiting period for the next wave to drive the turbine with another push. They had to depend on flywheels to keep the generators in motion whereas in this preferred embodiment the stored compressed air is used for different applications at will and set to run continuously, uniformly regulated at pre-set pressure without any interruptions and are not concerned about the frequency of waves to be in motion.

Secondary or Substitute Elements:

Fabrication Material:

The preferred embodiment can be made in full or in part or a combination of any or all from materials like wood, foaming material, cement, plastics, synthetic material, rubber, metal or composite material or a combination of any or all of the above to perform in part or in full, for any application whether mounted or fastened to the sea floor or ground or anchored by objects heavier than water or lighter, so long as it has a stabilizing frame, a bidirectional pump or pumps mounted on a single float or multiple floats, a network of pipes whether ridged or flexible to carry compressed air, compressed air holding tanks made from any metal, steal, fiberglass or any composite material to withstand the air compression, air turbine or turbines to cause clockwise or counter clockwise motion to turn on the generator or generators with a gear system or direct drive and made from the material mentioned above and they follow the underlying principle to keep the float to cause up and down movement for the piston for pumping action whereas the other part of the pump must be kept stationary.

It does not matter if the cylinder is kept in motion and the piston is stationary, the principal is to keep one part of the pump stationary at a time for maximum efficiency. The stationary part may be totally ridged or may swing sideways but it must be guided either by wheels, slides or confined space to allow the moving part to move freely with minimum friction and damage to the pump or pumps.

Design Flexibility

The design of this preferred embodiment can be made in a variety of ways. Some designs are shown in the drawings however the principle process is:

First, to keep one part of the pump stationary and to use the other part as float for creating movement in a bidirectional pump and specifically up and down movement of the waves to compress air as stored energy.

Secondly the process or technology involves two piton attached with a rod or pipe or pipes in which larger piston is used as a float, guided to move in “up and down” movement with waves and the other end smaller piston, housed in the stationary pump to transmit the energy of the float piston to the pump piston. In the pump assembly either the pump housing or the piston inside can be made stationary for full gain of energy but not both.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A new ocean wave energy extracting system in the form of compressed air is claimed comprising:
(a) A machine and a process to harnessing sea wave energy using sea wave bouncy and kinetic energy both within a single wave curve is claimed.
(b) An ocean wave energy extracting system, said system comprising:
A bidirectional but single piston pump directly operated by two forces, one by the wave power of bouncy and secondly by and kinetic energy by using the weight of the float, its attached connecting embodiment and the piston, dropping down the float after the first bump of the wave guided by rails or slides provided for the float movement, using its built in kinetic energy to compress the trapped air inside the lower half chamber of the pump, working as a double pumping device on both directions using up and down movement of the wave to extract its maximum energy possible in its size.
(c). An ocean wave energy extracting system as claimed in claim (a) & (b) comprising: multiple one way valves incorporated in the pump cylinder of the said bidirectional piston pump compressing the air, based on the ratio of the float size against the piston surface area enclosed inside the pump and driving the compressed air through valves on both sides of the upper and lower wave pressure cycles for collection as compressed air energy and wherein this compressed air is stored in compressed air tanks for different applications including generating electricity.
(d). An ocean wave energy extracting system as claimed in claim (a)(b)& (c) comprising:
A process in which one section of the bidirectional air pump is kept stationary to let the moving piston perform its compression in both direction effectively wherein the bidirectional pump may be positioned under or over water and wherein the stationary part or structure is fastened or bolted with the sea floor to restrict its movement in any direction as against its free end.

2. An ocean wave energy extracting system as claimed in this invention using float as part of the “piston open end” wherein the smaller end of the piston in enclosed in a body of cylinder pump to compress air.
(a). An ocean wave energy extracting system as claimed in this invention to use the float as a balancing device between its own weight and the wave bouncy to keep and continue bidirectional compression of air.

3. An ocean wave energy extracting system as claimed in this invention wherein the unit operates using two different working mediums independently and at the same time in conjunction with each other in total sync automatically.
(a). The process claimed involves two piston attached with a rod or pipe or pipes in which larger piston is used as a float, guided to move in “up and down” movement with waves and the other end smaller piston, housed in the stationary pump to transmit the energy of the float piston to the pump piston. In the pump assembly either the pump housing or the piston inside can be made stationary for full gain of energy but not both.
(b). A machine and a process to produce compressed air energy by sea waves using bounacy and kinetic energy in a single cylinder in a most simple reliable yet economical way. The process also utilizes the sinking wave cycle for 100% increased efficiency. comprising:
(c) The Float;
The float weight is set to a variable range preferable with available water, as compared to other floats where its sole purpose is to be all out over the surface to remain afloat for the following reasons;
(1) When the float raises up by wave action and its attached piston compress the air in the preferred embodiment device, the air is drawn in the lower chamber of the cylinder by its open valve and when the wave passes, the combined weight of the float its connecting rod and piston compresses the air down that is trapped inside the lower chamber to keep on the compression in the next half cycle in the lower chamber. In other words the kinetic energy that is built during the raising cycle of the float is used to compress the air again in its free fall position resulting in a net gain of double energy extraction by this preferred embodiment;
(2) In the current embodiment the float weight is a balancing tool to match the bouncing strike with the free fall weight stroke to efficiently use the compression of the opposing chamber to capture the other half energy of the wave;
(3) The float is not designed for stabilization by any positive displacement of air or by any other device as it is heavily emphasized by the current technology. In this preferred embodiment, the principle is reverse and a maximum destabilization of the float is a requirement however a path is provided for movement to run a pumping action on both ends of the cylinder with a single piston;
(4) This unique process makes the float a larger piston working with water as medium, whereas the smaller piston connected with a shaft works with the air medium inside the pump to amplify the pressure psi directly proportional to the ratio between the smaller piston and the larger piston “(The Float)”;
(5) Some prior art has tried to use tension wires, springs or other mechanical methods to pull the float back but it inversely affects the performance of the compression in the first cycle and because of the resistance it deceases its compression by wasting this energy;
(6) The float design may be round, oval, triangle, square, rectangle, parallelogram, trapezoid, diamond shape, octagon, pentagon, hexagon, can, cube, cross, bevel, donut, chevron or any of these or a combination of these shapes, either hollow or solid or both can be made so long as they follow the basic principle of floatation and transmitting the motion of the waves to the piston;
(d) Bi-directional Pump;
In some prior art bidirectional pumps have been made with complex mechanism and especially their complexity is housed inside the pump body which seriously compromises its air volume in its size by taking space due to their design to let the air a passage by internal tubing and that drops its efficiency. In the current embodiment there is no junk inside the pump housing except its simple piston connected with a rod for its movement to produce useful energy. All necessary tubing is designed outside the pump housing giving the pump not only simplicity but also great efficiency by its enhanced air volume. No other kind of pump provides that simplicity and efficiency by comparison;
(e) Energy extraction in shallow water;
Many inventors have tried to put all the mechanical jargon like a complete electrical system with electrical generators at the site and since they are designed for deep sea sites therefore they cannot perform with efficiency at shallow water sites. This preferred embodiment is designed for shallow water coast line wave energy extraction and collection or processing is land based. Low compressed air is produced by using both sides of the wave curve by direct bi-directional pumping. Land based compressed air tanks store that compressed air in the holding tanks and in the second phase the holding tanks energy is boosted by air powered boosters for high compression and transferred into high pressure tanks for either transportation like other fuel, electricity generation or used as a compressed air station;
(f) Direct driven system;
This is the simple most direct pumping system to get compressed air. The prior art was designed to use the compressed air to drive electric turbines directly, that are dependent upon the availability of waves, their strength and a waiting period for the next wave to drive the turbine with another push. They had to depend on flywheels to keep the generators in motion whereas in this preferred embodiment the stored compressed air is used for different applications at will and set to run continuously, uniformly regulated at pre-set pressure without any interruptions and are not concerned about the frequency of waves to be in motion.

4. It is claimed to incorporate a tidal/storm surge calibration system in the preferred embodiment by using hoist, or hydraulics with a timer or manual calibration to keep the air pumps and their floats at a measured distance by adjusting the height of the pumps and their floats at any given preset height shown in FIG. 10, as well as to avoid damage due to oversized surge for continuous un-interrupted smooth operation but it does not preclude any deep water wave power generator based on the same principle of producing compressed air as stored energy for making electricity or any other direct application.
(a) The definition of hoist in this preferred embodiment is not limited to the conventional hoist, but will apply to any electrical, fuel powered, hydraulic or manual system using gears, pulleys, ropes, chains, belts or otherwise to raise or lower any compressed air energy production platform mounted on a fixture in the sea will be called hoist operated within the definition of this preferred embodiment.
